(19) United States
(12) Patent Application Publication
(10) Pub. No.: US 2011/0236742 A1
(43) Pub. Date: Sep. 29, 2011

(54) FAULT PROTECTION BATEERY COVER ASSEMBLY

(76) Inventors: Ping-Hua Deng, Dongguan (CN); Peng Wang, Dongguan (CN)

(21) Appl. No.: 12/730,210

(22) Filed: Mar. 23, 2010

(51) Int. Cl. H01M 2/26

(52) U.S. Cl. 429/121

(57) ABSTRACT

A fault protection battery cover assembly consists of a platform having a plurality of holes disposed thereon, a positive and a negative terminal for providing electricity output, and a positive and a negative terminal connecting bar for providing connection with an internal circuit. Said terminals and terminal connecting bars are insulatedly disposed at a top and a bottom of said platform. The terminal connecting bars are connected electrically with said terminals by a plurality of fastening elements, and characterized in that a fuse is attached onto said positive terminal to cut off the circuit as overcurrent is generated.

### FIELD OF THE INVENTION

The present invention relates to a fault protection battery cover for increasing safety of the battery.

### BACKGROUND OF THE INVENTION

With environmental and global warming issues rising, alternative power sources are developed and utilized for replacing fossil fuel which powers the traditional internal combustion engine. Among multiple power sources, electricity is one of the favorable choices. To be used for propulsion, such as electric car, electricity is usually stored in multiples high capacity batteries (>10 AH) for long-term use. Such high capacity battery releases high electric current and produces great amount heat, reducing the stability and safety as any excess current may overheats the lead wire causing short circuit and will eventually lead to an explosion, making disaster. Therefore, to design a safety device for increasing the security of the battery in order to protect the user has become the main object of the present invention.

### SUMMARY OF THE INVENTION

To achieve aforementioned objective, a fault protection battery cover assembly is realized by consisting of a platform having a plurality of holes disposed thereon, a positive and a negative post for providing connection with an external circuit, and a positive and a negative terminal connecting bar for providing connection with an internal circuit. Said posts and terminal connecting bars are insulatedly disposed at a top and a bottom of said platform. The terminal connecting bars are connected electrically with said terminals by a plurality of rivets. To prevent huge current being dumped from the batter and causing fire, the battery cover is characterized in that the positive terminal is connected to a fuse which is fixed thereto by the rivets.

The fuse composes of a conducting plate and two connecting plates joining to the conducting plate by two fusible portions. Multiple connecting plates split the current generated by the battery, thus to avoid fire or explosion of battery caused by overheating.

The top of the rivet which for securing the fuse is provided with a projection and said projection is accommodating in a corresponding locating hole disposed on each connecting plate. The engagement of the projection and locating hole ensures the fuse being attached to the positive terminal securely.

### BRIEF DESCRIPTION OF DRAWINGS

FIG. 1 is an exploded view of the fault protection battery cover of the present invention.

FIG. 2 is a cross sectional view of the present invention.

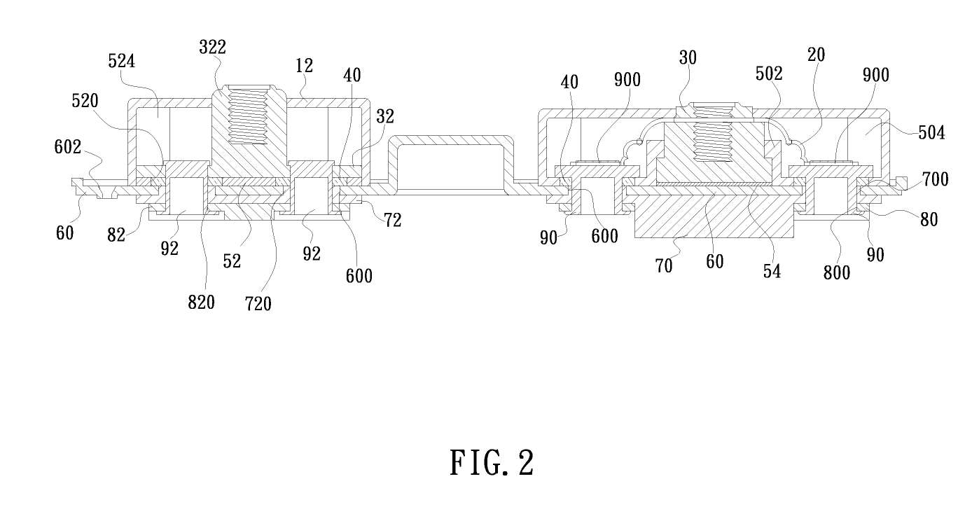

FIG. 3 is an enlarged view of FIG. 2, focusing on the positive terminal portion of said battery cover.

FIG. 4 is an enlarged view of FIG. 2, focusing on the negative terminal portion of said battery cover.

FIG. 5 is a perspective view of the fault protection battery cover claimed in the present invention provided onto a battery.

### DETAIL DESCRIPTION OF PREFERRED EMBODIMENTS

The preferred embodiment of the present invention is described in detail according to the appended drawings hereinafter.

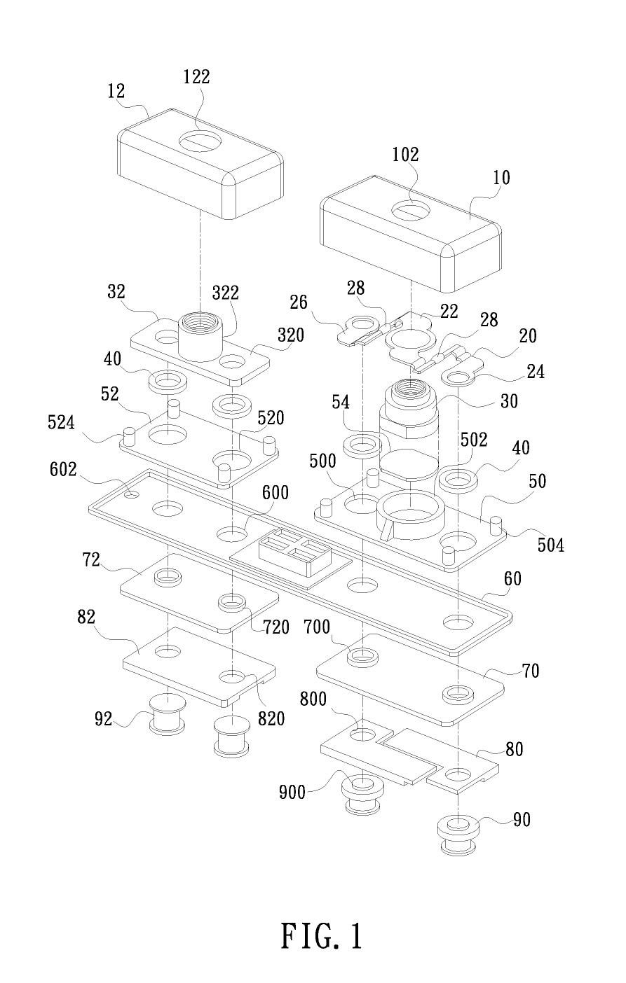

Referring to FIG. 1, a fault protection battery cover assembly consists essentially of a platform (60) having a plurality of holes (600) disposed thereon, a positive and a negative terminal (30, 32) for providing connection with an external circuit, and a positive and a negative terminal connecting bar (80, 82) for providing connection with an internal circuit. Said terminals (30, 32) and terminal connecting bars (80, 82) are insulatedly disposed at a top and a bottom of said platform (60). The terminal connecting bars (80, 82) are connected electrically with said terminals (30, 32) by a plurality of first and second rivets (90, 92), and characterized in that said the positive terminal (30) is connected to a fuse (20) by the first rivet (90).

The positive and negative terminals (30, 32) are housed by a positive and a negative cap (10, 12). A hole (102) is set on the center top of the positive cap (10) and another hole (122) is set on the center top of the negative cap (12). The positive cap (10) is relatively longer than the negative cap (12) as it houses the fuse (20) also.

The fuse (20) shown in FIG. 1 comprises of a conducting plate (22) attached to said positive terminal (30) and two connecting plates (24, 26) having a hole provided thereon are extended from two opposite lateral sides thereof. Each connecting plate (24, 26) is coupled to the conducting plate (22) by a fusible portion (28). The two fusible portions (28) can cut the connection to avoid overheating of the battery. The fuse (20) illustrated in FIG. 1 has two fusible portions (28), however, fuse with multiple fusible portion (not shown) can also be applied in the present invention.

Said positive terminal (30) is a post in stepped post with an axial hole having a screw thread (not shown) provided on the inner wall thereof. The negative terminal (32) is composed of a substrate (320) and a cylinder (322) projected upwardly. A hole is sized at two extreme ends respectively for receiving the second rivet (92). A screw thread is set at inner wall of the cylinder (322).

An upper positive insulating plate (50) is placed between the platform (60) and the positive terminal (30). A hole (500) is sized at two proximal ends of the plate (50) respectively for accommodating an O-ring (40) on each end. A locating well (502) is provided in the center portion of said plate (50) and an inner wall of said locating well (50) of the upper positive insulating plate (50) having a corresponding shape for receiving the positive terminal (30). Four locating poles (504) are provided at four corners of the insulating plate (50). An upper negative insulating plate (52) which shares similar structure is set between the platform (60) and the negative terminal (32). A hole (520) is sized at two proximal ends of the plate (52) respectively for accommodating said O-ring (40) and four locating poles (524) are provided at four corners of the insulating plate (52). Said upper negative insulating plate (52) doesn't include the locating well as disclosed by plate (50).

The platform (60) is a board in a rectangular shape covered by a rupture membrane (not shown). Four assembling apertures (600) which correspond with holes (500) of upper positive insulating plate (50) and holes (520) of upper negative insulating plate (52) are disposed on the platform (60) and a filling aperture (602) is set at a side thereof for refilling the liquid of battery.

A lower positive and a lower negative insulating plate (70, 72) are placed under said platform (60). Both plates (70, 72) include two projected ring portions (700, 720) respectively which correspond with said refilling apertures (600) for engaging the plates (70, 72) and the platform (60).

Said positive terminal connecting bar (80) is assembled by two symmetrical L-shape terminal tabs which each tab connects electrically to said connecting plate (24, 26) by the first rivets (90). A hole (800) which corresponds with the filling aperture (600) of the platform (60) is provided at the shorter portion of the tab. The negative terminal connecting bar (82) is in a rectangular shape having two holes (820) corresponding the filling apertures (600) of the platform (60).

The first and second rivets (90, 92) are hollow fastening elements having an end sealed and a projection (900) is provided on the top of the first rivet (90).

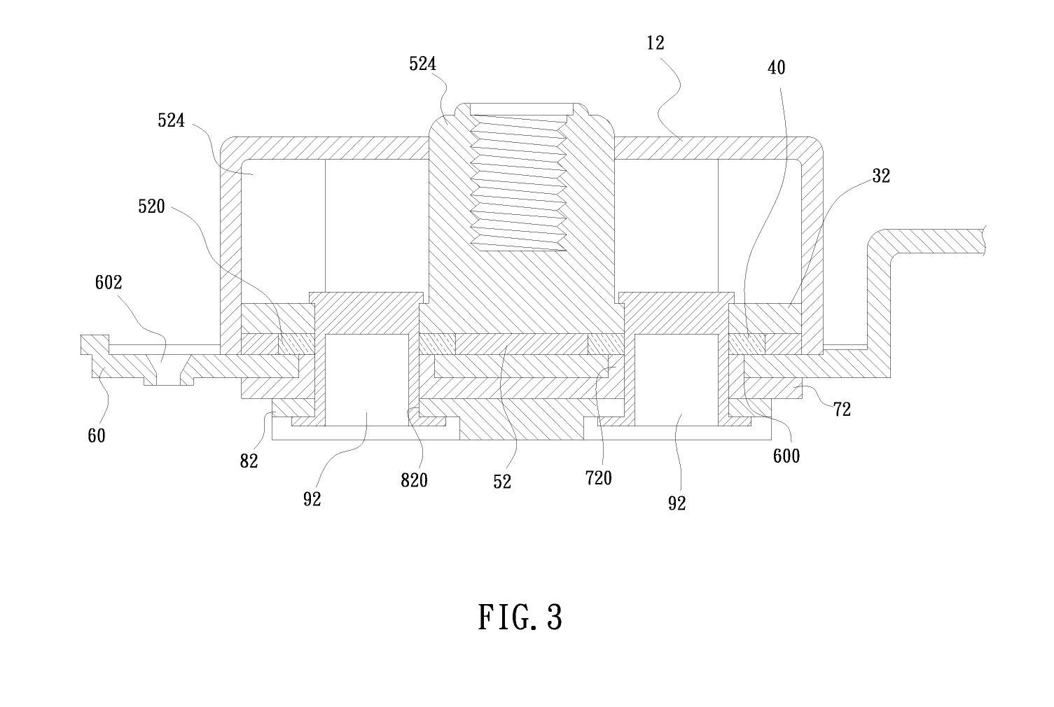

The assembly of the positive terminal is well shown by referring to FIG. 3. The positive terminal (30) and positive terminal connecting bar (80) are fixed to both the top and bottom sides of the platform (60) by first rivets (90). Said upper positive insulating plate (50) is provided between the terminal (30) and platform (60), and the lower positive insulating plate (70) is provided between the terminal connecting bar (80) and platform (60) for insulation purpose. Each of two O-rings (40) is received within the hole (500) of the insulating plate (50).

Said positive terminal (30) passes through the locating well (502) of the upper positive insulating member (50). The corresponding step-like inner wall has the terminal (30) secured within the well (502). A gasket (54) is disposed under the bottom of the positive terminal (30) as an insulator to avoid electric conduction with the platform (60). Two first rivets (90) are riveted, therefore, one end of each joints the holes (500) and the other end thereof joints each positive terminal connecting bar (80). The top portion of said positive terminal (30) which passes through the locating well (502) engages to the hole provided on the conducting plate (22) and the projection (900) of each first rivet (90) engages with hole provided on connecting plates (24, 26) respectively. The fuse (20) is attached onto the positive terminal (30) and first rivets (90) by any common known fastening method. The positive terminal portion is housed by the positive cap (10). The cap (10) includes a passage hole (102) for allowing positive terminal to be exposed externally and connected electrically to an external circuit.

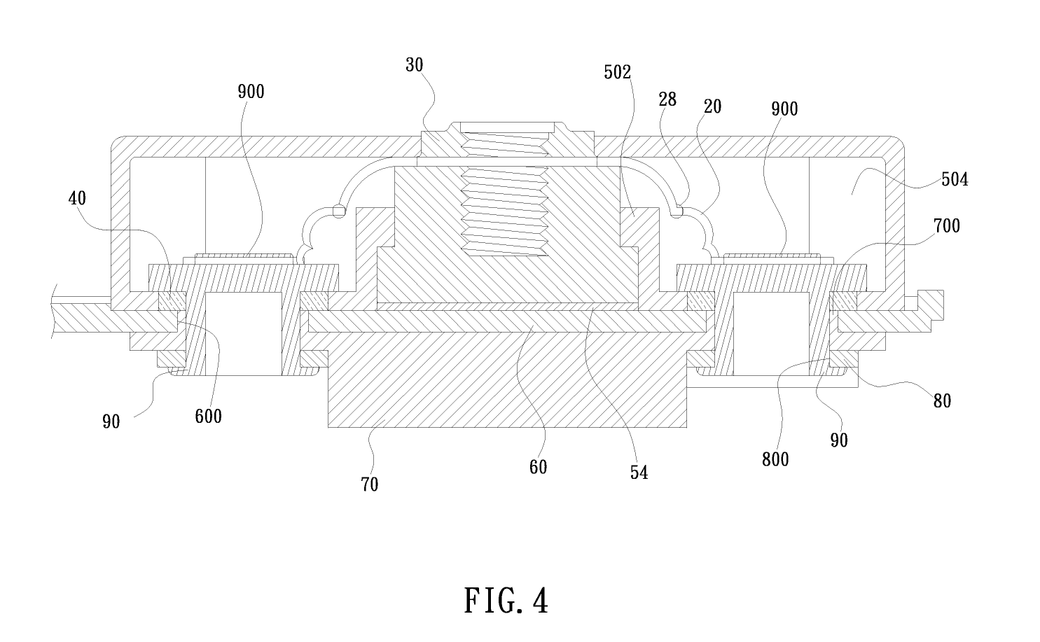

Details of the assembly of the negative terminal of said battery cover is shown by referring to FIG. 4. The negative terminal (32) and negative terminal connecting bar (82) are affixed to the top and bottom surfaces of the platform (60) by second rivets (92). Said upper negative insulating plate (52) is provided between the negative terminal (32) and platform (60), and the lower negative insulating plate (72) is provided between the terminal connecting bar (82) and platform (60) for insulation purpose. Each of two O-rings (40) is received within the hole (520) of the insulating plate (52). Two second rivets (92) are riveted, therefore, one end of each attached to the holes (520) and the other end thereof attached to each negative terminal connecting bar (82). The negative terminal portion is housed by the negative cap (12). The cap (12) includes a passage hole (122) for allowing negative terminal (32) to be exposed externally and connected electrically to an external circuit.

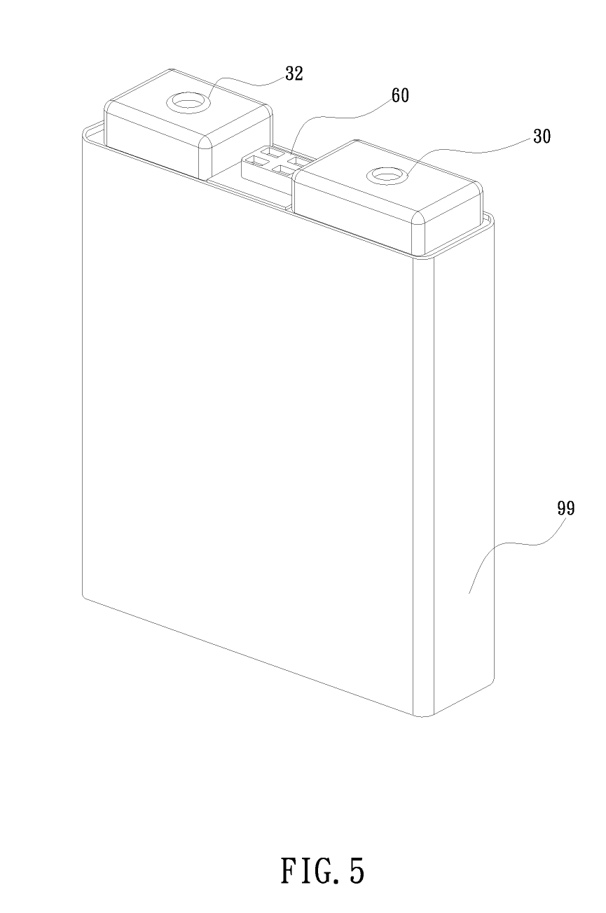

To prevent any accident from overheating, the aforementioned battery cover is attached onto a battery (99) as shown in FIG. 5. Two positive terminal connecting bars (80) split positive current generated by the battery (99) into two equal but eventually weaker currents. The split currents pass two first rivets (90), connecting plates (24, 26) and are rejoined by the fuse (20). When the current passing the positive terminal is overloaded, the fusible portions (28) which join connecting plates (24, 26) with the conducting plates (28) cut the circuit off to prevent explosion of the battery from any short-circuit.

The fuse (20) shown in FIG. 1 has two fusible portions, however, fuse with multiple fusible portions can also be applied for this application. Since the battery (99) is commonly assembled by connecting multiples power units in parallel fashion, numbers of fusible portions can correspond with the number of power units which the battery (99) is composed of. Numbers of positive terminal connecting bar (80) and first rivet (90) should also be concordant with the number of the fusible portions. Thereby, each power unit connected in parallel connect the positive terminal (30) independently and when any power unit generates abnormal current, the fusible portion thereof will be cut off to ensure the battery (99) function properly.

The present invention has been described via the detailed illustration of the preferred embodiment. Those skilled in the art can derive variations from the preferred embodiment without departing from the scope of the present invention. For example, the fastening elements which are the first and second rivet (90, 92) can be selected from other traditional fastening means, such as screws or nuts. The fuse (20) can also be applied onto the negative terminal (32) or applied to both terminals (30, 32). Therefore, the preferred embodiment shall not limit the scope of the present invention defined in the claims.

1. A fault protection battery cover assembly consists essentially of a platform having a plurality of holes disposed thereon, a positive and a negative terminal for providing connection with an external circuit, and a positive and a negative terminal connecting bar for providing connection with an internal circuit; said terminals and terminal connecting bars are insulatedly disposed at a top and a bottom of said platform; said terminal connecting bars are connected electrically with said terminals by a plurality of fastening elements, and characterized in that said positive terminal is connected to a fuse by the fastening element.

2. The fault protection battery cover assembly of claim 1, wherein said fuse is a double-joint fuse or a multiple-joint fuse.

3. The fault protection battery cover assembly of claim 1, wherein each head of said fuse is connected to the connecting plate by a fastening element.

4. The fault protection battery cover assembly of claim 1, wherein said fuse comprises of a conducting plate attached to a positive terminal and two connecting plates extending from two opposite lateral sides of the positive terminal; said positive terminal connecting bar is assembled by two symmetrical terminal tabs which each connecting electrically to said connecting plate by the fastening element.

5. The fault protection battery cover assembly of claim 4, wherein each connecting plate of said fuse is connected to the conducting plate by a fusible portion.

6. The fault protection battery cover assembly of claim 1, wherein said fastening element is a rivet.

7. The fault protection battery cover assembly of claim 1, wherein an upper positive insulating plate and upper positive insulating gasket are provided between said positive terminal and the platform for providing insulation; the positive terminal and positive terminal connecting bar are joined by two fastening elements, in which each has an end riveted to said upper positive insulating plate and another end riveted to the positive terminal connecting bar; a hollow locating well is extended upwardly from said upper positive insulating plate and the hollow portion of said locating well is sized to receive said positive terminal, fixing the terminal to the conducting plate of said fuse.

8. The fault protection battery cover assembly of claim 7, wherein each of said fastening elements has a projection provided at a top and a corresponding hole is sized at each connecting plate of the fuse for receiving and fixing the fastening element.

9. The fault protection battery cover assembly of claim 7, wherein said positive terminal is a stepped post and an inner wall of said locating well of the upper positive insulating plate having a corresponding shape for receiving the positive terminal.

10. The fault protection battery cover assembly of claim 1, wherein said battery cover further includes a positive and a negative terminal cap for housing corresponding terminal and fuse; each cap has a hole disposed at top thereof to allow corresponding terminal to pass and connecting with the external circuit.
